(19) United States
(12) Patent Application Publication
(10) Pub. No.: US 2016/0069384 A1
(43) Pub. Date: Mar. 10, 2016

(54) RADIAL PLAIN BEARING

(71) Applicant: Voith Patent GmbH, Heidenheim (DE)

(72) Inventors: Steffen Kämmerer, Immenstadt (DE); Ralph Rudolph, Rettenberg (DE)

(73) Assignee: Voith Patent GmbH, Heidenheim (DE)

(21) Appl. No.: 14/943,394

(22) Filed: Nov. 17, 2015

Related U.S. Application Data
(63) Continuation of application No. PCT/EP2014/059827, filed on May 14, 2014.

(30) Foreign Application Priority Data
May 17, 2013 (DE) 10 2013 209 193.1
May 14, 2014 (DE) 10 2014 209 062.8

(51) Int. Cl. F16C 17/03; F16C 43/02; F16C 37/00; F16C 33/10

(52) U.S. Cl. CPC F16C 17/03; F16C 33/1065; F16C 43/02; F16C 37/00

(57) ABSTRACT

A radial plain bearing having a plurality of tilting pads for supporting a shaft, the tilting pads being movable relative to the bearing housing and being arranged circumferentially around and at a distance from the bearing axis, whereby the tilting pads have an outer radial plain bearing surface that can be supported on a supporting surface of a pressure block provided in the bearing housing; wherein the pressure block is movably provided in a passage extending radially through the bearing housing and can move radially without being supported on the bearing housing, the pressure block is secured against rotation in the circumferential direction of the passage by way of an anti-rotation element, and at least part or all of a radial outer surface of the pressure block is located on a common cylinder surface with an outer diameter of the bearing housing or with a bushing surrounding the bearing housing.

### CROSS REFERENCE TO RELATED APPLICATIONS

This is a continuation of PCT application No. PCT/EP2014/059827, entitled “RADIAL PLAIN BEARING”, filed May 14, 2014, which is incorporated herein by reference.

### BACKGROUND OF THE INVENTION

1. Field of the Invention

The invention relates to a radial plain bearing. The invention moreover relates to a method for installing a radial plain bearing with support of the tilting pads on the bearing connection surroundings.

2. Description of the Related Art

Radial plain bearings are known in various designs from the current state of the art. The following publications are referenced as being representative:
U.S. Pat. No. 5,738,447 A
U.S. Pat. No. 6,485,182 B
DE 60110751 T2
DE 69503138 T2
EP 2 339 192 A1
DE 19514830 C2
GB 2285491A
DE 602004003239 T2
EP 1859175 B1
CH 558 481 A.

The radial plain bearing includes a bearing housing having a bearing bore aligned along a bearing axis and having a number of tilting pads for supporting a shaft, said pads being movable relative to the bearing housing and being arranged circumferentially around the bearing axis at a distance from the latter, whereby the individual tilting pad has an outer radial plain bearing surface that can be supported on a supporting surface of a pressure block provided in the bearing housing.

At least an indirect support of tilting pads is thereby provided on the bearing housing.

When being used in turbo-transmissions the characteristics of such mountings, in addition to the geometry of the shafts, determine thereby definitively the rotor-dynamic characteristics. Previous bearing concepts are characterized by a relatively complex design, expensive manufacture and/or space-intensive construction, particularly in the radial direction.

### SUMMARY OF THE INVENTION

The present invention provides a radial plain bearing for the use of mountings shafts that rotate at high speed that can be operated at a higher speed and bearing pressure, with lower bearing clearance variation in stationary operation, less bearing deformation and improved vibration characteristics; so that it meets the requirements in applications with high circumferential speeds even more effectively, it is characterized by a rigid pad support and moreover allows a radial space saving design and in regard to manufacturing technology is simple and cost-effectively mountable.

A radial plain bearing including a bearing housing having a bearing bore aligned along a bearing axis and having a number of tilting pads for supporting a shaft, said pads being movable relative to the bearing housing and being arranged circumferentially around the bearing axis at a distance from the latter, whereby the individual tilting pad has an outer radial plain bearing surface that can be supported on a supporting surface of a pressure block provided in the bearing housing, is characterized according to the invention in that the individual pressure block is movably provided in a passage extending radially through the bearing housing and can move radially without being supported on the bearing housing, that said block is secured against rotation in the circumferential direction of the passage by way of an anti-rotation element and that at least part or all of the radial outer surface of the pressure block is situated on a common cylinder surface with the outer diameter of the bearing housing or with a bushing surrounding said housing.

Bushings are used in particular when for example the bearing housing is a cast component and is too soft for the application. The bushing surrounding the bearing housing is for example an eccentric bushing.

The radial plain bearing according to the invention facilitates a rigid support of the tilting pads due to direct force transmission into the bearing connection surrounding and is therefore also suitable for mounting of shafts that rotate at very high speeds. The radial plain bearing according to the invention is moreover constructively simple and easy to install.

The support of the bearing surface on the supporting surface can occur directly or via interposition of additional components. During operation of the radial plain bearing a lubricating film can be provided between bearing surface and supporting surface.

The individual pressure block features at least one guide region for guidance in the bearing housing; and in installation position at the radial inside end region features a support region for creation of the supporting surface, wherein the guide region is designed such that a clearance fit is provided between the outside circumference and the passage; and the guide region has an extension in radial direction that is dimensioned such that the supporting region is not in contact with the inside circumference of the bearing housing.

In one advantageous embodiment the individual pressure block and/or the tilting pad are manufactured from a material having an elasticity module greater than 200 GPa, in particular greater than 250 GPa. Technical ceramics are the preferred choice of material. These facilitate high radial rigidity and at the same time good thermal conductivity. An additional advantage is found in the clearly lower coefficients of thermal expansion which clearly reduce the danger of bearing clearance reductions due to overheating in intermittent operation.

For ease of manufacture the individual passages in the bearing housing are created round or oval in their cross sections.

In one advantageous further development a lubricant and/or coolant system is provided which comprises at least one annular groove extending over at least one section in circumferential direction around the bearing housing and which—when viewed in the direction parallel to the bearing axis—is arranged in the region of the bearing center or eccentrically offset to same, whereby the annular groove is connected via at least one radial bore in the housing with a nip that is formed between the individual tilting pads and the inside circumference of the bearing housing. The design with the central annular groove allows the integration of the pressure blocks in their radial outer end region for this function.

The radial movability of the pressure block inside the passage and securing in circumferential direction occurs by means of an anti-rotation element which includes a locking element, in particular a threaded pin that is passed through the wall of the bearing housing, and which is effective with clearance at the guide region of the pressure block. As a result of its design it can already be utilized as an assembly aid during the assembly of the bearing.

In the high performance range at least 3 to 7 tilting pads, advantageously 4 to 5 tilting pads, are preferably used for supporting radial plain bearings.

A process for installation of a radial plain bearing is characterized by the following process steps:
provision of a bearing housing having a bearing bore aligned along a bearing axis and a plurality of passages extending from the inside circumference to the outside circumference in radial direction relative to the bearing axis;
provision of pressure blocks with a supporting region and a guide region connecting in longitudinal direction of the pressure block that—in circumferential direction relative to the passage—is designed having a clearance fit and is oversized relative to its extension in installation position in longitudinal direction;
provision of tilting pads;
insertion of the pressure blocks in the passages and securing of the oversized pressure blocks on the outside diameter of the bearing housing with respect to the installed condition of the radial plain bearing and the tilting pads by way of a calibration device on the bearing housing by adjusting the nominal dimension of the bearing in H6—tolerance;
machining, in particular cylindrical grinding of the outside circumference to the outside circumference of the bearing housing.

The method allows great size accuracy of the bearing since the adjustment can be made directly via the position of the pressure blocks during assembly.

The pressure block can especially advantageously be braced in respect to the passage by means of a fastening element of a positively locking anti-rotation element that is any case provided in the installation condition of the bearing.

In the case of a central annular groove on the outside surface of the bearing housing, the annular groove for a lubrication and cooling system can be integrated in a further embodiment into the bearing housing and/or the pressure block when machining the outside circumference.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a simplified schematic illustration in a perspective view of a radial plain bearing according to the invention;

FIG. 2a is a simplified schematic illustration in an axial section of the radial plain bearing of FIG. 1, supporting a shaft in a static load;

FIG. 2b illustrates the radial plain bearing of FIG. 2, with the tilting pad in a tilted orientation;

FIG. 3a is a perspective view of a section of the radial bearing of FIG. 1;

FIG. 3b is a section view through A-A of FIG. 3a;

FIG. 4 is a perspective view of another section of the radial bearing of FIG. 1;

FIG. 5 is a perspective view illustrating the bearing housing of the radial plain bearing of FIG. 1;

FIG. 6 is a perspective view of a pressure block of the radial plain bearing of FIG. 1;

FIG. 7a is a section illustration of the bearing housing of the radial plain bearing of FIG. 1;

FIG. 7b is a side view of a pressure block of the radial plain bearing of FIG. 1;

FIG. 7c illustrates an initial assembly of the bearing housing, tilting pad, and pressure block of the radial plain bearing of FIG. 1;

FIG. 7d illustrates the final manufactured configuration of the bearing housing, tilting pad, and pressure block of the radial plain bearing of FIG. 1; and

FIG. 8 illustrates an alternate embodiment of the bearing housing of the radial plain bearing of FIG. 1.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

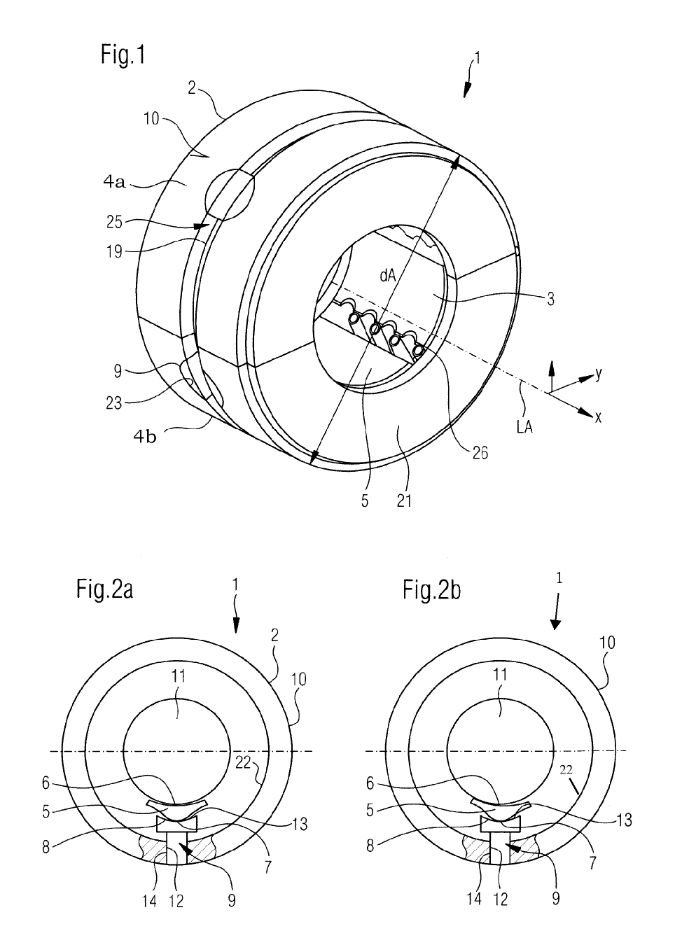

FIG. 1 is a simplified schematic illustration in a perspective view of an inventively designed radial plain bearing 1. This includes a bearing housing 2 having a bearing bore 3 extending along a longitudinal axis. The longitudinal axis forms at the same time the bearing axis LA. For clarification of the individual directions an exemplary coordinate system is herein applied to bearing axis LA. The x-axis coincides with bearing axis LA and describes the extension along same or respectively in the axial direction. The y-axis describes the extension in the radial direction.

FIGS. 2a and 2b show in schematized and strongly simplified illustration a section of a radial plain bearing 1, as illustrated in FIG. 1 in an axial section. FIG. 2a clarifies the arrangement of the components for the support of a shaft 11 under static load. FIG. 2b, by way of a view according to FIG. 2a, contrast illustrates radial plain bearing 1 in a tilted state of tilting pad 5.

Bearing housing 2 can be formed by a cylindrical sleeve. It consists preferably of at least two half shells 4a and 4b. A design that is not illustrated here, consisting of several partial shells that are arranged adjacent to one another in circumferential direction around bearing axis LA and which can be connected with one another through frictional and/or positive locking, is also conceivable. Radial plain bearing 1 moreover includes a number of tilting pads 5 being arranged movable relative to bearing housing 2 and being arranged in circumferential direction adjacent to one another around longitudinal axis LA at a distance from same. Tilting pads 5 serve to support a shaft around its axis—said shaft not being illustrated in FIG. 1 and identified as 11 in FIGS. 2a, 2b. In installation position, viewed in a radial direction, originating from the bearing axis they respectively comprise a radial inside supporting surface 6 and a radial outside bearing surface 7, with which tilting pads 5 support themselves at least indirectly on a connecting component, in particular a supporting surface 8. Supporting surface 8 is arranged on a pressure block 9 that is movably guided in bearing housing 2 in radial direction and is secured in same to prevent rotating. According to the invention, pressure block 9 is designed and arranged such that, in the installation position of the radial plain bearing, it does not support directly on bearing housing 2; and extending through bearing housing 2 in radial direction is flush with outside circumference 10 of bearing housing 2 or a bushing. The support of the forces thus occurs directly via pressure block 9 into the bearing connection vicinity; this means the radial outside 23 of pressure block 9 is positioned at least partially, preferably completely with outside diameter dA of bearing housing 2 on a common cylinder surface.

The guidance of pressure block 9 in bearing housing 2 occurs in passages 12 arranged radially in same and extending through the wall thickness; in other words, from inside circumference 22 to outside circumference 10. The movability of pressure block 9 in the radial direction is realized via a clearance between outside circumference 10 of pressure block 9 that is guided in passage 12, and inside circumference 22 of passage 12. A simple fit is sufficient herein.

To realize the support function and formation of supporting surface 8, pressure block 9 is characterized by at least two regions in regard to its design, a first supporting region 13 and a second guide region 14. The function of supporting region 13 exists in the formation of supporting surface 8. The function of guide region 14 consists in the guide function in bearing housing 2. Supporting region 13 and guide region 14 are designed accordingly. Supporting region 13 is—in regard to its size relative to a center axis of pressure block 9 which coincides with the center axis of passage 12 in installation position—larger than guide region 14. In the illustrated case supporting surface 6 that is located on tilting pad 5 is convex. Consequently, supporting surface 8 on pressure block 9—viewed in circumferential direction around shaft 11—is designed concave.

The specific geometric design of pressure block 9 can vary. Passage 12 is preferably circular or oval. The design of guide region 14 of pressure block 9 is complementary thereto, having a circular or oval cross section.

Pressure block 9 is preferably symmetrical, relative to a plane that is characterized by a center axis of pressure block 9 and a vertical line relative to same in installation position in the axial direction. Supporting region 13 extents in installation position at the radial inside end region of pressure block 9 on both sides beyond guide region 14 and is thus—viewed in circumferential direction around bearing axis LA—designed with a protrusion on both sides. This is also the case for the extension in the axial direction.

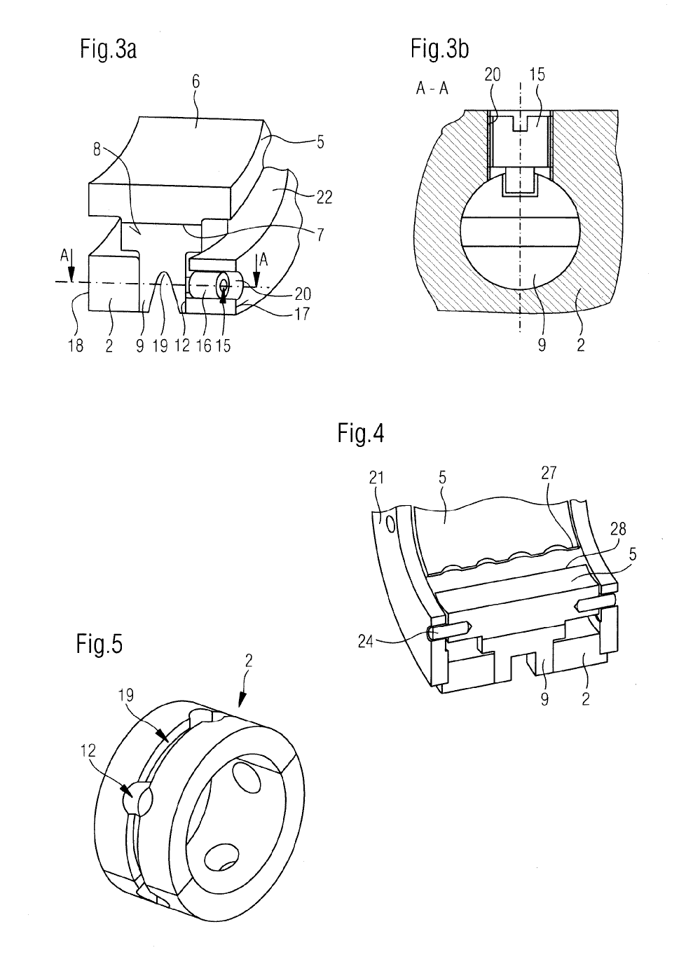

By way of an illustration according to FIG. 2a, FIG. 2b clarifies the support in a load condition. One can see slight tilting of tilting pad 5 and thereby of supporting surface 6 relative to the outside circumference of shaft 11 that is to be supported. It can moreover be recognized that supporting region 13 on its side facing guide region 14 is arranged at a distance from inside circumference 22 of bearing housing 2 and is thus not supported directly on bearing housing 2. To avoid undesirable rotation around an axis describing the progression of passage 12 in the radial direction, an anti-rotation element 15 is provided (FIG. 3A). There are a multitude of possibilities regarding the specific design of same. We refer representatively to the embodiments in FIGS. 3a and 3b which illustrate the function of the anti-rotation element in a sectional plane that is characterized by bearing axis LA of radial plain bearing 1 and a vertical line relative to same. In the simplest case, anti-rotation element 15 includes a fixing means in the form of threaded pins 16 that become effective on the outside circumference of guide region 14 of pressure block 9.

FIG. 3a illustrates a section of a view in an axial sectional plane. One can see bearing housing 2 extending in its axial direction, pressure block 9 after assembly and tilting pad 5 that—viewed in radial direction—is supported in axial and circumferential direction over a contact region on supporting surface 8 of pressure block 9. Originating from lateral surfaces 17 and respectively 18 of bearing housing 2, anti-rotation element 15 is positioned perpendicular to same. In the simplest case a threaded pin 16, originating from one lateral surface 17 in bearing housing 2 is guided in threaded bore 20 extending in direction toward passage 12 and ending in same. Threaded bore 20 progresses preferably orthogonally to passage 12.

FIG. 3b shows the arrangement and design of anti-rotation element 15 in a section A-A of FIG. 3a. Anti-rotation element 15 becomes effective on the outside circumference of guide region 14 of pressure block 9. Threaded pin 16 of anti-rotation element 15 engages herein in recesses on the outside circumference of guide region 14 and interacts in particular during assembly with same through friction by securing pressure block 9 in its location inside passage 12 in the radial direction.

In a perspective view FIG. 4 illustrates in an axially vertical section through radial plain bearing 1 the arrangement of the individual components relative to each other, and securing of tilting pads 5 in radial and circumferential directions with clearance, via pad locking pins 24 on lateral plates 21. During storage and transportation the function of the pad locking pins 24 exists in preventing tilting pads 5 from dropping out or moving in a radial or tangential or circumferential direction inside a permissible clearance. For this purpose the pad locking pins 24 can either be firmly connected with the lateral plates 21 and engaging with clearance into tilting pads 5, or vice versa. The individual connection can be a positive or frictional connection.

FIGS. 1-4 illustrate an especially advantageous embodiment of a radial plain bearing 1 with a lubricant and coolant supply system 25 that is allocated to said radial plain bearing 1 and that is not illustrated here in detail, comprising an annular groove 19 in circumferential direction around the longitudinal axis on the outside circumference of bearing housing 2. Annular groove 19 is an integral part of the coolant supply system.

Annular groove 19 is arranged centrally relative to the axial extension of radial plain bearing 1 Annular groove 19 is thereby worked into the material of bearing housing 2 and arranged outside 23 of pressure block 9 that is flush with outside circumference 10 of bearing housing 2 and facing away from shaft 11. Annular groove 19 is connected via at least one connection bore with radial direction component in bearing housing 2 with a space between the individual tilting pads 5.

This connection channel guides the lubricant into the region between tilting pad 5 and inside circumference 22 of bearing housing 2 and shaft surface 11.

The lubricant and coolant being used for radial plain bearing 1 according to the invention is normally oil. However, the use of water or another mixture is also conceivable. The function of annular groove 19 consists in the oil supply of each nip formed by a respective tilting pad 5 and shaft 11 that is to be supported. The illustrated embodiment of annular groove 19 represents an especially advantageous design. Embodiments with grooves symmetric to the bearing center on the outside diameter of bearing housing 2 and thus outside of pressure block 9 are also conceivable.

Supply strips 26 for lubricant and coolant are moreover provided which are conductively connected with annular groove 19 via the connection channels, in particular oil channels. Supply strips 26 and the oil channels are preferably tilted relative to a radial beam. The longitudinal axis of the oil channels can for example be arranged in an axis-vertical section through the bearing axis according to secant lines on the circle that is limited by the shell surface of shaft 11. The supply to tilting pad 5 occurs on the side of run-in edge 27. This is understood to be the edge of tilting pad 5 that—in rotational direction of shaft 11—is first swept over by shaft 11. Run-out edge 28 is the edge of the same tilting pad 5 that is positioned after run-in edge 27 in rotational direction of shaft 11. An especially effective injection of lubricant and coolant into the nip is ensured due to the aforementioned tilting. According to an especially advantageous design each of the supply strips 26 includes threaded bores for screwing in of metering screws.

FIG. 5 illustrates one embodiment of bearing housing 2. One can recognize passages 12 that are arranged central in the axial vertical section and which are provided in a complementary number to the number of tilting pads 5 that are to be supported and which are uniformly spaced relative to each other and are arranged in circumferential direction adjacent to one another.

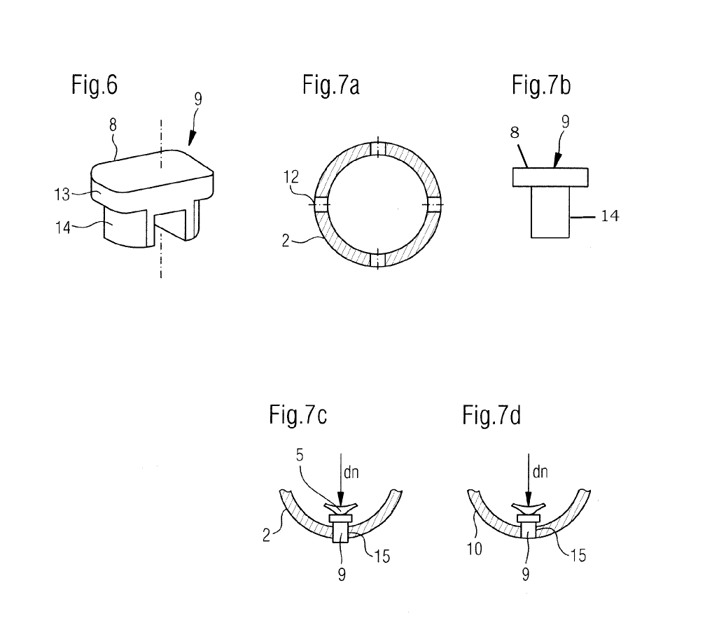

FIG. 6 illustrates pressure block 9 as suited for the design of radial plain bearing 1 according to FIGS. 1-4.

FIGS. 7a-d clarify in schematically simplified illustration the individual assembly steps in the assembly of radial plain bearing 1. According to FIG. 7a bearing housing 2 is provided with passages 12 for accommodation of pressure blocks 9, said passages extending in a radial direction from inside to outside circumference. FIG. 7a shows the bearing housing bushing 2. As already mentioned, this may be multi-part. FIG. 7b illustrates pressure block 9, provided with at least two partial regions, guide region 14 and the supporting region forming support surface 8 for realization of the load bearing and supporting function. Pressure block 9 can be designed with already incorporated partial region of annular groove 19 in guide region 14. It is however also conceivable to design guide region 14 as a single component also in the region that is flush with the outside circumference of bearing housing 2. In addition, individual tilting pads 5 are provided. In an additional process step in FIG. 7c, the positioning of the individual components—bearing housing 2, pressure block 9 and tilting pad 5—relative to each other occurs. Individual pressure blocks 9 are hereby inserted from the side of inside circumference 22 of bearing housing 2 into passage 12 with guide region 14. With respect to its extension in installation location, guide region 14 of pressure block 9 is designed as an oversized prefabricated basic component. The positioning of tilting pads 5 in their position defining the installation location occurs through positioning of tilting pad 5 relative to respective pressure block 9 and applying pressure upon individual pressure block 9 and tilting pad 5 against an adjusting bolt for the adjustment of the required tolerance which is located centrally in bearing housing 2. Fixation occurs by means of an anti-rotation element, in this case a threaded pin 16 which pretensions pressure block 9 relative to passage 12 in the radial direction, meaning pressure blocks 9 with tilting pads 5 are pushed against an adjusting bolt and are held in position through bracing of anti-rotation element 15 (see FIG. 3a). As already mentioned, in this position they are slightly oversized relative to the outside circumference of bearing housing 2. In an additional process step a condition according to FIG. 7d is produced by means of cylindrical grinding, wherein the radial outside 23 of pressure block 9 and the outside diameter of the bearing housing 2 are positioned on a common cylinder surface. This ensures that the inside circle that contacts the pads tangentially describes the nominal dimension of the bearing with tolerance H6. In a functional concentration during assembly, anti-rotation element 15 assumes the responsibility of fixing the position of tilting pads 5 via fixing of pressure blocks 9 and secures pressure blocks 9 during operation against rotation with clearance at the same time in the radial direction.

In order to further increase rigidity of radial plain bearing 1, the material of pressure block 9 should contain an elasticity modulus that is greater than that of steel. Values greater than 200 GPa are hereby to be strived for. Technical ceramics are considered as choice of material. Technical ceramic offers the advantage of excellent thermal conductivity. Moreover, low coefficients of thermal expansion compared to hitherto used pad materials. This reduces the risk of inadmissible reduction of the bearing clearance due to intermittent thermal deformations and the thereby created high bearing temperatures that could lead to shutting down of the system.

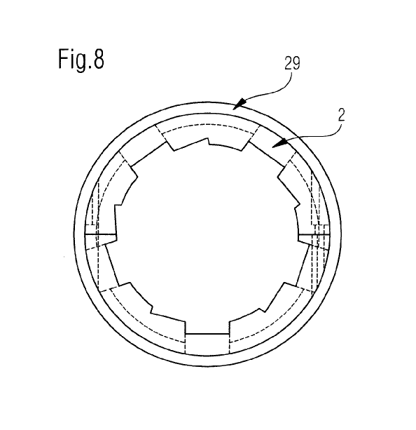

For utilization of the bearing in bearing connection surroundings whose material properties differ from those of the bearing housing and whereby there is a danger that their functionality is impaired during operation due to wear and tear, bearing housing 2 is being enclosed by a bushing on the outside circumference. The outside circumference of the bushing then forms the contact surface with the bearing connection surrounding and the pressure parts support themselves on the inside circumference of the bushing. FIG. 8 illustrates in a schematic strongly simplified illustration an example of such an embodiment, whereby bearing housing 2 in this case consists for example of two bearing housing shells, surrounded by a support ring in the form of a bushing 29.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION LIST

1 radial plain bearing

2 bearing housing

3 bearing bore

4a, 4b bearing shell

5 tilting pad

6 supporting surface

7 bearing surface

8 support surface

9 pressure block

10 outside circumference

11 shaft

12 passage

13 support region

14 guide region

15 anti-rotation element

16 threaded pin

17 lateral surface

18 lateral surface

19 annular groove

20 threaded bore

21 lateral plate

22 inside circumference

23 radial outside

24 pad locking pin

25 lubricant and coolant supply system

26 supply strips

27 run-in edge

28 run-out edge

29 bushing

LA bearing axis

1. A radial plain bearing, including a bearing housing having a bearing bore aligned along a bearing axis and having a plurality of tilting pads for supporting a shaft, the tilting pads being movable relative to the bearing housing and being arranged circumferentially around and at a distance from the bearing axis, whereby the tilting pads have an outer radial plain bearing surface that can be supported on a supporting surface of a pressure block provided in the bearing housing;
wherein the pressure block is movably provided in a passage extending radially through the bearing housing and can move radially without being supported on the bearing housing, the pressure block is secured against rotation in the circumferential direction of the passage by way of an anti-rotation element, and at least part or all of a radial outer surface of the pressure block is located on a common cylinder surface with an outer diameter of the bearing housing or with a bushing surrounding the bearing housing.

2. The radial plain bearing of claim 1, wherein the pressure block includes at least one guide region for guidance in the bearing housing; and in installation position at a radial inside end region includes a supporting region for creation of the supporting surface, wherein the guide region is designed such that a clearance fit is provided between an outside circumference of the pressure block and the passage; and the guide region has an extension in the radial direction that is dimensioned such that the supporting region is not in contact with an inside circumference of the bearing housing.

3. The radial plain bearing of claim 1, wherein at least one of the pressure block and the tilting pad are manufactured from a material having an elasticity modulus greater than 200 GPa.

4. The radial plain bearing of claim 1, wherein at least one of the pressure block and the tilting pad are manufactured from a material having an elasticity modulus greater than 250 GPa.

5. The radial plain bearing of claim 1, wherein the passage in the bearing housing has a round or oval cross-section.

6. The radial plain bearing of claim 1, wherein at least one of a lubricant system and a coolant system is provided which includes at least one annular groove extending over at least one section in a circumferential direction around the bearing housing and which, when viewed in the direction parallel to the bearing axis, is arranged in the region of the center of the bearing or eccentrically offset to same, whereby the annular groove is connected via at least one radial bore in the bearing housing with a nip that is formed between the tilting pads and the inside circumference of the bearing housing.

7. The radial plain bearing of claim 2, wherein the anti-rotation element includes a locking element that is passed through the wall of the bearing housing, and which functions with the clearance fit provided between the guide region of the pressure block and the passage.

8. The radial plain bearing of claim 7, wherein the locking element is a threaded pin.

9. The radial plain bearing of claim 1, wherein between three and seven tilting pads are provided.

10. The radial plain bearing of any of claim 1, wherein between three and five tilting pads are provided.

11. A method for assembly of a radial plain bearing comprising:
provision of a bearing housing having a bearing bore aligned along a bearing axis and a plurality of passages extending from the inside circumference to the outside circumference in a radial direction relative to the bearing axis;
provision of pressure blocks with a supporting region and a guide region connecting in a longitudinal direction of the pressure block that, in a circumferential direction relative to the passage, is designed having a clearance fit and is oversized relative to its extension in the installation position in the longitudinal direction;
provision of tilting pads;
insertion of the pressure blocks in the passages and securing of oversized pressure blocks on the outside diameter of the bearing housing with respect to the installed condition of the radial plain bearing and the tilting pads by way of a calibration device on the bearing housing by adjusting the nominal dimension of the radial plain bearing to H6 tolerance;
machining of the outside circumference of pressure block until it is flush with the outside circumference of the bearing housing.

12. The method of claim 11, wherein the pressure block is braced to the passage by way of a fastening element of a positively locking anti-rotation element.

13. The method of claim 11, wherein machining the outside circumference of the bearing housing creates an annular grove for a lubrication and cooling system integrated into at least one of the bearing housing and the pressure block.
